(19) United States
(12) Patent Application Publication
(10) Pub. No.: US 2010/0239060 A1
(43) Pub. Date: Sep. 23, 2010

(54) REFLECTOR-CONTROLLED FAST REACTOR

(75) Inventors: Hideki Horie, Kanagawa-ken (JP); Yasuyuki Moriki, Kanagawa-ken (JP); Kenji Igarashi, Kanagawa-Ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/679,200

(22) PCT Filed: Sep. 19, 2008
(86) PCT No.: PCT/JP2008/066992

§ 371 Date: Mar. 19, 2010

(30) Foreign Application Priority Data
Sep. 21, 2007 (JP) 2007-244913

(51) Int. Cl. G21C 7/06

(52) U.S. Cl. 376/220

(57) ABSTRACT

In a reflector-controlled fast reactor in which neutron reflectors disposed outside a rector core, immersed in a primary coolant, are moved vertically to thereby adjust leakage of neutrons from the reactor core and control reactivity of the rector core, a region, which is located around the reactor core and in which the neutron reflectors move, is surrounded by a material inferior to the primary coolant in terms of neutron reflection capability.

### TECHNICAL FIELD

The present invention relates to a reflector-controlled fast reactor (fast reactor having reactivity control reflectors) that controls the reactivity in a reactor core by vertically moving reflectors disposed outside the reactor core immersed in a primary coolant made of a liquid metal so as to adjust the amount of leakage of neutrons from the reactor core.

### BACKGROUND TECHNOLOGY

Patent Document 1 (Japanese Patent Laid-Open No. 6-174882) discloses an example of a structure of a conventional fast reactor.

FIG. 19 is an axial cross-sectional view showing an example of a configuration of a conventional fast reactor.

As shown in FIG. 19, a conventional fast reactor 50 includes a reactor core 2 formed of nuclear fuel assemblies, and the reactor core 2 has a substantially cylindrical shape as a whole. The outer circumference of the reactor core 2 is surrounded by a core barrel (or tank) 3, which protects the reactor core 2. A plurality of reflectors 4 is disposed outside the core barrel 3 so as to circularly surround the core barrel as a whole. A partition wall (barrier) 6, which forms an inner wall of a coolant flow path 5 through which a primary coolant flows, is provided outside the reflectors 4 so as to surround the outer periphery thereof. A reactor vessel 7, which forms an outer wall of the coolant flow path 5, is disposed outside the partition wall 6 with a spaced therefrom. A neutron shield 8 is disposed in the coolant flow path 5 so as to surround the reactor core 2. A guard vessel 9, which protects the reactor vessel 7, is provided outside the reactor vessel 7.

The space provided between the core barrel 3 and the partition wall 6 forms a region where the reflectors 4, which are used to operate the reactor core 2, are moved. Each of the reflectors 4 is suspended by a drive shaft 11 passing through an upper plug 10 and supported in such a way that the reflector 4 can be moved by a reflector drive apparatus 12 in the vertical direction. That is, the drive shaft 11 and hence the reflector 4 are moved in the vertical direction in the movement region between the core barrel 3 and the partition wall when the reflector drive apparatus 12 is driven. The leakage of neutrons from the reactor core 2 can be adjusted by moving the reflectors 4, and the reactivity in the reactor core 2 is controlled.

The reactor core 2, the core barrel 3, the partition wall 6, and the neutron shield 8 are mounted on and supported by a core support plate 13. The partition wall 6 extends upward from the core support plate 13, on which the reactor core 2 is mounted, and the annular space between the partition wall 6 and the reactor vessel 7 forms the coolant flow path 5. An annular electromagnetic pump 14 is disposed in the coolant flow path 5 above the neutron shield 8 disposed therein. An intermediate heat exchanger 15 is disposed above the electromagnetic pump 14. A decay heat removal coil 16 is disposed above the intermediate heat exchanger 15.

The intermediate heat exchanger 15 and the electromagnetic pump 14 are integrated with each other and further continuously connected to and suspended by an outer shroud 23, which is an upper structure of the conventional fast reactor 50. The intermediate heat exchanger 15 has a tube and a shell through which the primary coolant and a secondary coolant flow, respectively. A seal bellows 17, which absorbs expansion and contraction due to heat generated in the conventional fast reactor 50 and defines the coolant flow path 5, is provided between a lower end portion of the intermediate heat exchanger 15/electromagnetic pump 14 and an upper end portion of the partition wall 6. The intermediate heat exchanger 15 has an inner barrel (tank) 20 and an outer barrel (tank) 21, and a heat transfer tube 22 is disposed between the inner barrel 20 and the outer barrel 21.

The conventional fast reactor 50 uses a plutonium-containing nuclear fuel in the reactor core 2. In operation, the plutonium in the reactor core 2 undergoes nuclear fission accompanied by heat generation, and extra fast neutrons are absorbed by depleted uranium to produce more plutonium than that burned and consumed in amount. The reflectors 4 reflect the neutrons radiated from the reactor core 2 to accelerate burning and breeding of the nuclear fuel in the reactor core 2. The reflectors 4 are gradually moved from a lower level to an upper level while the critical point of the nuclear fuel is maintained during the burning of the nuclear fuel. By moving the reflectors 4, a new portion of the fuel in the reactor core 2 can be gradually burned, thereby maintaining the burning of the nuclear fuel for a long period.

In the operation of the conventional fast reactor 50, the reactor vessel 7 is filled with liquid sodium, which is the primary coolant, and the primary coolant cools the reactor core 2 and extracts the heat generated in the nuclear fission process.

The solid arrows shown in FIG. 19 indicate the direction in which the primary coolant flows. As indicated by the solid arrows, the primary coolant is moved by the electromagnetic pump 14 downward through the coolant flow path 5, passes through the neutron shield 8, and reaches the bottom of the reactor vessel 7. The primary coolant is then turned in direction so as to flow upward through the reactor core 2, and the temperature of the primary coolant is increased by the heat generated in the nuclear fission of the nuclear fuel in the reactor core 2. The heated primary coolant flows into the tube of the intermediate heat exchanger 15 located in an upper portion of the reactor vessel 7. Further, the primary coolant flows out of the intermediate heat exchanger 15 after performing the heat exchange with the secondary coolant therein, and is moved downward again by the operation of the electromagnetic pump 14. Unlike the primary coolant, the secondary coolant externally enters the conventional fast reactor 50 through an inlet nozzle 18 and flows into the shell of the intermediate heat exchanger 15. Thereafter, the secondary coolant is heated by the primary coolant in the intermediate heat exchanger 15 and then flows out of the conventional fast reactor 50 through an outlet nozzle 19. The heat of the secondary coolant is converted into, for example, power for driving an electric generator.

Patent Document 2 (Japanese Patent Laid-Open No. 6-51082) discloses an example of a structure of the reflectors 4.

FIG. 20 is a schematic axial cross-sectional view showing an example of a configuration of a conventional reflector.

As shown in FIG. 20, a box 24 having a space 24a formed therein is integrally connected to an upper portion of each of the reflectors 4. The space 24a is in a vacuum condition or contains a gas, which is inferior to the primary coolant in terms of neutron reflection capability. The upper end of the box 24 is connected to the lower end of the corresponding drive shaft 11. The thus configured reflector 4/box 24 allows the reactivity of the nuclear fuel to be kept at a level lower than that in a case where the portion outside the core barrel 3 is filled with the primary coolant. As a result, the enrichment of the nuclear fuel can be increased and hence the reactivity lifetime in the reactor core 2 can be prolonged.

The temperature of the primary coolant in the conventional fast reactor 50 is approximately 500° C. on the side where the reactor core 2 is present in the core barrel 3, whereas being approximately 350° C. on the side where the neutron shield 8 is present outside the partition wall 6, resulting in temperature difference of approximately 150° C. between the core barrel 3 and the partition wall 6. Further, when passing through the reactor core 2, the primary coolant is heated from approximately 350° C. to approximately 500° C., resulting in axial temperature difference of approximately 150° C. in the core barrel 3. The temperature difference could damage the box 24 provided above the reflector 4 due to thermal stress and creep produced in the box 24. When the box 24 is damaged and the primary coolant enters the space 24a in the state of vacuum or containing a gas, the box 24 no longer has the advantageous effect of keeping the reactivity of the nuclear fuel at a low level. In an event wherein the box 24 no longer has the advantageous effect of keeping the reactivity of the nuclear fuel at a low level, the worth of the reflector 4 decreases.

### DISCLOSURE OF THE INVENTION

The present invention has been conceived in consideration of the circumstances encountered in the prior art described above, and an object of the present invention is to provide a fast reactor (fast reactor having reactivity control reflectors) in which a coolant present between a reactor core and reflectors is removed to thereby decrease in neutron reflection toward the reactor core in a region where the reflectors move, decrease in reactivity of a nuclear fuel, and increase in resistance to the temperature environment around the reactor core.

To achieve the above object, the present invention provides a reflector-controlled fast reactor in which a neutron reflector disposed outside the rector core is moved vertically to adjust leakage of neutrons from the reactor core to thereby control reactivity of the rector core, wherein a region, which is located around the reactor core and in which the neutron reflector moves, is surrounded by a material inferior to the coolant in terms of neutron reflection capability.

Furthermore, the present invention also provides a reflector-controlled fast reactor in which a neutron reflector disposed outside the rector core is moved vertically to adjust leakage of neutrons from the reactor core to thereby control reactivity of the rector core, wherein a box containing a material inferior to the coolant in terms of neutron reflection capability is disposed above the neutron reflector, and the neutron reflector and the box are disposed in a reflector guide tube.

According to the present invention having the subject features described above, there is provided a fast reactor in which a coolant present between a reactor core and reflectors can be eliminated to thereby decrease the neutron reflection toward the reactor core in a region where the reflectors move, decrease the reactivity of a nuclear fuel, and increase the resistance to the temperature environment around the reactor core.

### BRIEF DESCRIPTION OF THE DRAWINGS

FIG. 1 is an axial cross-sectional view showing a configuration of a reflector-controlled fast reactor according to a first embodiment of the present invention.

FIG. 2 is a plan cross-sectional view showing a schematic configuration of a reactor core section of the reflector-controlled fast reactor according to the first embodiment of the present invention.

FIG. 3 is a plan cross-sectional view showing a schematic configuration of another reactor core section of the reflector-controlled fast reactor according to the first embodiment of the present invention.

FIG. 4 is a plan cross-sectional view showing a schematic configuration of another reactor core section of the reflector-controlled fast reactor according to the first embodiment of the present invention.

FIG. 5 is a plan cross-sectional view schematically showing how void tubes, which surround a reactor core of the reflector-controlled fast reactor according to the first embodiment of the present invention, are constrained.

FIG. 6 is a plan cross-sectional view schematically showing how the void tubes, which surround the reactor core of the reflector-controlled fast reactor according to the first embodiment of the present invention, are constrained.

FIGS. 7A, 7B, and 7C are plan cross-sectional views schematically showing how the void tubes, which surround the reactor core of the reflector-controlled fast reactor according to the first embodiment of the present invention, are constrained.

FIG. 8 is an axial cross-sectional view showing a configuration of a reflector-controlled fast reactor according to a second embodiment of the present invention.

FIG. 9 is a plan cross-sectional view showing a schematic configuration of small-diameter tube portions of void tubes that form the reflector-controlled fast reactor according to the second embodiment of the present invention.

FIG. 10 is a plan cross-sectional view showing a schematic configuration of a reflector disposed in each of the void tubes that form a reflector-controlled fast reactor according to a third embodiment of the present invention.

FIG. 11 is a plan cross-sectional view showing a schematic configuration of a reflector disposed in each of the void tubes that form a reflector-controlled fast reactor according to a fourth embodiment of the present invention.

FIG. 12 is an axial cross-sectional view showing a configuration of a reflector-controlled fast reactor according to a fifth embodiment of the present invention.

FIG. 13 shows plan cross sections schematically showing how the void tubes, which surround the reactor core of the reflector-controlled fast reactor according to the fifth embodiment of the present invention, are constrained, in which FIG. 13(A) is a plan cross-sectional view schematically showing how large-diameter tube portions of the void tubes are constrained and FIG. 13(B) is a plan cross-sectional view schematically showing how small-diameter tube portions of the void tubes are constrained.

FIG. 14 is a plan cross-sectional view showing a schematic configuration of the reactor core section of a reflector-controlled fast reactor according to a sixth embodiment of the present invention.

FIG. 15 is a plan cross-sectional view showing a schematic configuration of the reactor core section of the reflector-controlled fast reactor according to the sixth embodiment of the present invention.

FIG. 16 is an axial cross-sectional view showing the configuration of a reflector-controlled fast reactor according to a seventh embodiment of the present invention.

FIG. 17 is a plan cross-sectional view schematically showing how the void tubes, which surround the reactor core of the reflector-controlled fast reactor according to the seventh embodiment of the present invention, are constrained.

FIG. 18 is an axial cross-sectional view showing a configuration of a reflector-controlled fast reactor according to an eighth embodiment of the present invention.

FIG. 19 is an axial cross-sectional view showing an example of a configuration of a conventional fast reactor.

FIG. 20 is a schematic axial cross-sectional view showing an example of a configuration of a conventional reflector.

### BEST MODE FOR EMBODYING THE INVENTION

A reflector-controlled fast reactor (fast reactor having reactivity control reflectors) according to the present invention will be described with reference to the accompanying drawings. Further, it is to be noted that terms of “upper”, “lower”, “right”, “left’ and the like terms are used herein with reference to the illustration of the drawings or actual installations.

### First Embodiment

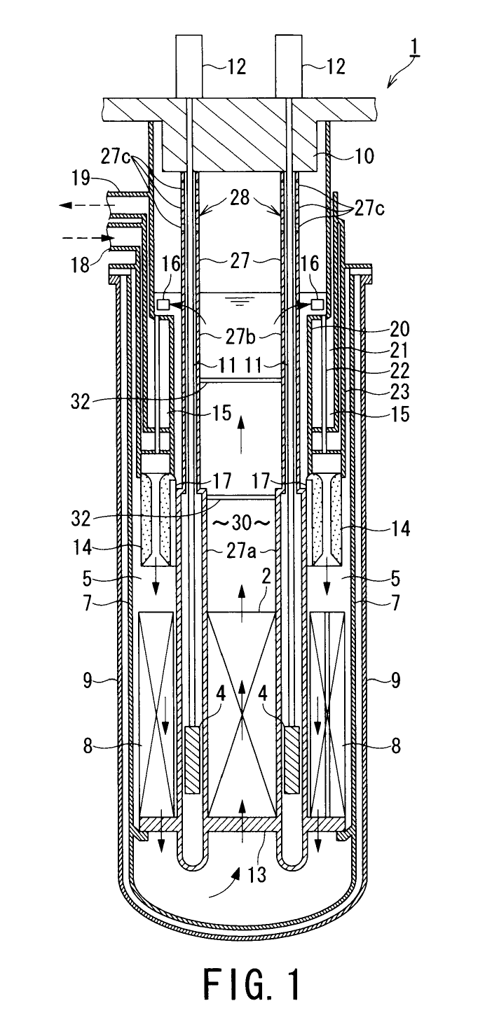

A first embodiment of the reflector-controlled fast reactor according to the present invention will be described with reference to FIGS. 1 to 7.

FIG. 1 is an axial cross-sectional view showing the configuration of the reflector-controlled fast reactor according to the first embodiment of the present invention.

As shown in FIG. 1, a reflector-controlled fast reactor 1 includes a reactor core 2 formed of nuclear fuel assemblies, and the reactor core 2 has a cylindrical shape as a whole. The outer configuration of the reactor core 2 is surrounded by a void tube group 28 formed of a plurality of void tubes 27. Reflectors (neutron reflectors) 4, which as a whole surround the reactor core 2, are disposed in the respective void tubes 27. The outer periphery of the void tube group 28 forms the inner wall of a coolant flow path 5, through which a primary coolant (coolant) 30 flows. A reactor vessel 7, which forms the outer wall of the coolant flow path 5, is disposed outside the void tube group 28 but spaced apart therefrom. A neutron shield 8 is disposed in the coolant flow path 5 and surrounds the reactor core 2. A guard vessel 9, which protects the reactor vessel 7, is provided outside the reactor vessel 7.

Each of the reflectors 4 is suspended by a drive shaft 11 passing through an upper plug 10 and supported in such a way that the reflector 4 can be moved by a reflector drive apparatus 12 in the vertical direction. That is, the drive shaft 11 and hence the reflector 4 are moved in the vertical direction in the corresponding void tube 27 when the reflector drive apparatus 12 is driven. By moving the reflectors 4, leakage of neutrons from the reactor core 2 can be adjusted, and hence, the reactivity in the reactor core 2 can be controlled.

Each of the void tubes 27, which forms a region in which the corresponding reflector 4 moves in the vertical direction, is formed of a large-diameter tube portion 27a, through which the reflector 4 can move in the vertical direction, and a small-diameter tube portion 27b, which is provided above the large-diameter tube portion 27a and into which the drive shaft 11 suspending the reflector 4 is inserted. The large-diameter tube portion 27a has a length over which the reflector 4 can move from the lower end to the upper end of the reactor core 2. On the other hand, the small-diameter tube portion 27b communicates with an upper end portion of the large-diameter tube portion 27a at a level lower than the liquid surface of the primary coolant 30.

The reactor core 2 and the neutron shield 8 are mounted on and supported by a core support plate 13. The void tubes 27 extend upward from the core support plate 13, on which the reactor core 2 is mounted, and the annular space between the outer configuration of the void tube group 28 formed of the void tubes 27 and the reactor vessel 7 forms the coolant flow path 5. An annular electromagnetic pump 14 is disposed in the coolant flow path 5 above the neutron shield 8 disposed therein. An intermediate heat exchanger 15 is disposed above the electromagnetic pump 14. A decay heat removal coil 16 is disposed above the intermediate heat exchanger 15.

The intermediate heat exchanger 15 and the electromagnetic pump 14 are integrated with each other and further continuously connected to and suspended by an outer shroud 23, which is an upper structure of the fast reactor 1. The intermediate heat exchanger 15 has a tube section and a shell section through which the primary coolant 30 and a secondary coolant flow, respectively. A seal bellows 17, which absorbs expansion and contraction due to the heat generated in the fast reactor 1 and defines the coolant flow path 5, is provided between a lower end portion of the intermediate heat exchanger 15/electromagnetic pump 14 and upper end portions of the large-diameter tube portions 27a of the void tubes 27. The intermediate heat exchanger 15 has an inner barrel portion 20 and an outer barrel portion 21, and a heat transfer tube 22 is disposed between the inner barrel portion 20 and the outer barrel portion 21.

The electromagnetic pump 14, the intermediate heat exchanger 15, and the decay heat removal coil 16 disposed above the neutron shield 8 are immersed in the primary coolant 30. The portion above the liquid surface of the primary coolant 30 is filled with a cover gas 31, which is formed of argon, neon, nitrogen or any other suitable inert gas, which allows neutrons to leak larger in amount than the primary coolant 30, that is, which is inferior to the primary coolant 30 in terms of neutron reflection capability.

A lower portion of the large-diameter tube portion 27a of each of the void tubes 27 is formed of a portion that abuts against the upper surface of the core support plate 13 and a portion that protrudes downward from the core support plate 13 and positions the corresponding reflector 4 below the lower end of the reactor core 2. The lower end of the large-diameter tube portion 27a is closed so that the primary coolant 30 does not flow into the void tube 27. The upper end of the small-diameter tube portion 27b of each of the void tubes 27 abuts against the upper plug 10 and is supported thereby. Gas introduction holes 27c, through which the region inside the small-diameter tube portion 27b communicates with the space filled with the cover gas 31, are provided in the small-diameter tube portion 27b. The cover gas 31 is introduced into the void tube 27 through the gas introduction holes 27c.

Two or more void tubes 27 of the void tube group 28 are connected via coupling shafts 32 so that the void tubes 27 are constrained from being displaced in the direction intersecting the longitudinal axis of the void tubes 27. The coupling shafts 32 are provided at levels higher than the upper end of the reactor core 2. For example, both the large-diameter tube portions 27a and the small-diameter tube portions 27b are provided with the coupling shafts 32. When the coupling shafts 32, which constrain the void tubes 27, are arranged in such a way that the void tube group 28 shows sufficient rigidity, the upper ends of the small-diameter tube portions 27b are not required to abut against the upper plug 10. In this case, if the upper end of each of the small-diameter tube portions 27b is opened, the gas introduction holes 27c can be eliminated in formation.

The fast reactor 1 uses a plutonium-containing nuclear fuel in the reactor core 2. In operation, the plutonium in the reactor core 2 undergoes nuclear fission accompanied by heat generation, and extra fast neutrons are absorbed by depleted uranium to produce plutonium more than that burned and consumed. The reflectors 4 reflect the neutrons radiating from the reactor core 2 to accelerate the burning and breeding of the nuclear fuel in the reactor core 2. The reflectors 4 are gradually moved from a lower level to an upper level while the critical point of the nuclear fuel is maintained during the burning of the nuclear fuel. Moving the reflectors 4 allows a new portion of the fuel in the reactor core 2 to be gradually burned, whereby the reactor core 2 can maintain the burning of the nuclear fuel for a long period.

In the operation of the fast reactor 1, the reactor vessel 7 is filled with liquid sodium, which is the primary coolant 30. The primary coolant 30 cools the reactor core 2 and extracts the heat generated in the nuclear fission process.

The solid arrows shown in FIG. 1 indicate the direction in which the primary coolant 30 flows. As indicated by the solid arrows, the primary coolant 30 is moved by the actuation of the electromagnetic pump 14 downward through the coolant flow path 5, passes through the neutron shield 8, and reaches the bottom of the reactor vessel 7. The primary coolant 30 is then redirected and flows upward through the reactor core 2, and the temperature of the primary coolant 30 is increased by the heat generated in the nuclear fission of the nuclear fuel in the reactor core 2. The heated primary coolant 30 flows into the tube of the intermediate heat exchanger 15 located in an upper portion of the reactor vessel 7. Further, the primary coolant 30 flows out of the intermediate heat exchanger 15 after performing the heat exchanging operation with the secondary coolant therein and is then moved downward again by the electromagnetic pump 14.

The broken arrows shown in FIG. 1 indicate the direction in which the secondary coolant flows. Unlike the primary coolant 30, the secondary coolant externally enters the fast reactor 1 through an inlet nozzle 18 and flows into the shell of the intermediate heat exchanger 15. Thereafter, the secondary coolant is heated by the primary coolant 30 in the intermediate heat exchanger 15 and then flows out of the fast reactor 1 through an outlet nozzle 19. The heat of the secondary coolant is converted into, for example, power for driving an electric generator.

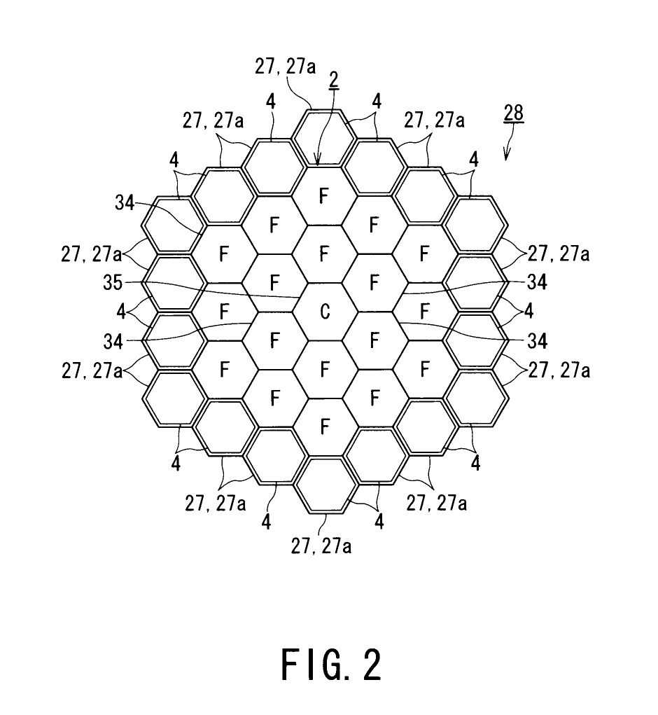

FIGS. 2 to 4 are plan cross-sectional views showing schematic configurations of a reactor core section of the reflector-controlled fast reactor according to the first embodiment of the present invention.

As shown in FIG. 2, the reactor core 2 is formed of fuel assemblies 34, each having a hexagonal cross-sectional shape, (indicated by the character F in FIG. 2). For example, 18 fuel assemblies 34 are arranged into a hexagonal shape as a whole. A reactor shutdown rod 35 (indicated by the character C in FIG. 2) is disposed at the center of the plurality of fuel assemblies 34 arranged into the hexagonal shape. The reactor shutdown rod 35 is a neutron absorbing rod for controlling the reactivity in the reactor core 2 and extracted upward when the fast reactor 1 is in operation.

The reactor core 2 formed of the fuel assemblies 34 and the reactor shutdown rod 35 is surrounded by the void tubes 27, each of which includes the large-diameter tube portion 27a having a hexagonal cross-sectional shape, like each of the fuel assemblies 34. For example, 18 void tubes 27 are disposed around the reactor core 2. That is, the void tube group 28 formed of the void tubes 27 is arranged into a hexagonal frame around the periphery of the reactor core 2. Each of the reflectors 4, which has a hexagonal cross-sectional shape, is disposed in the corresponding large-diameter tube portion 27a, which has a hexagonal cross-sectional shape, but spaced apart from the inner wall of the large-diameter tube portion 27a.

That is, the reactor core 2 and the void tube group 28 have a multi-layered structure, in combination, with the reactor shutdown rod 35 disposed at the center, the fuel assemblies 34 disposed around the reactor shutdown rod 35, and the void tubes 27 disposed around the fuel assemblies 34.

The cover gas 31, with which the portion above the liquid surface of the primary coolant 30 is filled, is introduced into the large-diameter tube portions 27a of the void tubes 27 through the gas introduction holes 27c provided in the small-diameter tube portions 27b. Further, the reflectors 4 are disposed in the large-diameter tube portions 27a in such a way that the reflectors 4 can move in the vertical direction along the fast reactor 1. The small-diameter tube portion 27b of each of the void tubes 27 can have a cross-sectional shape through which the drive shaft 11 that suspends the corresponding reflector 4 can be inserted. For example, the cross-sectional shape of the small-diameter tube portion 27b may be circular, elliptical, or polygonal.

The outer circumference of the void tube group 28 formed of the void tubes 27 disposed around the reactor core 2 forms the inner wall of the coolant flow path 5.

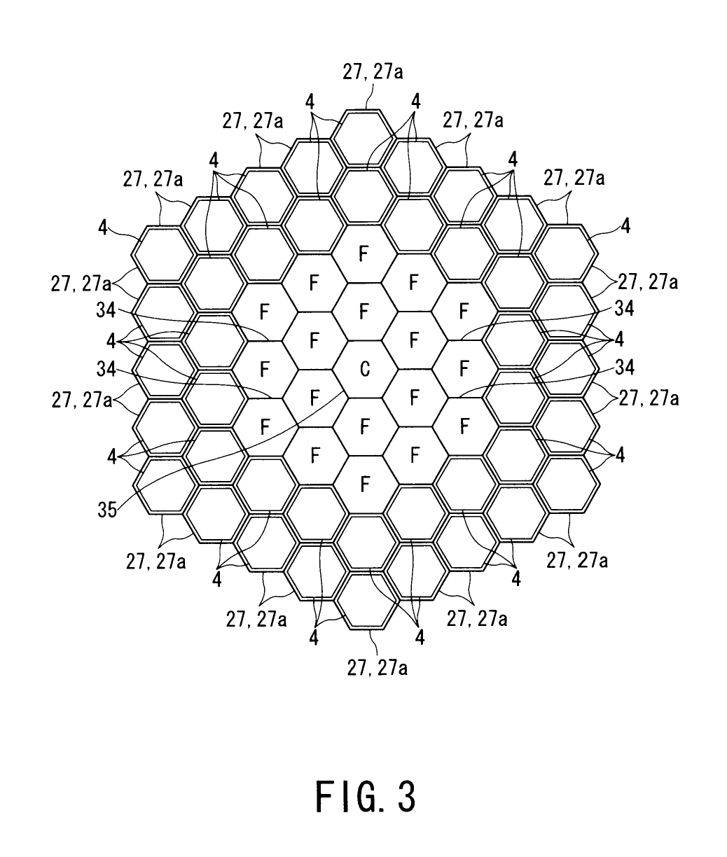

Alternatively, as shown in FIG. 3, the void tubes 27, which surround the reactor core 2, can be arranged into a hexagonal frame of a plurality of rows to the peripheral portion around the reactor core 2. For example, twenty-four void tubes 27 that form two layers are disposed around the reactor core 2.

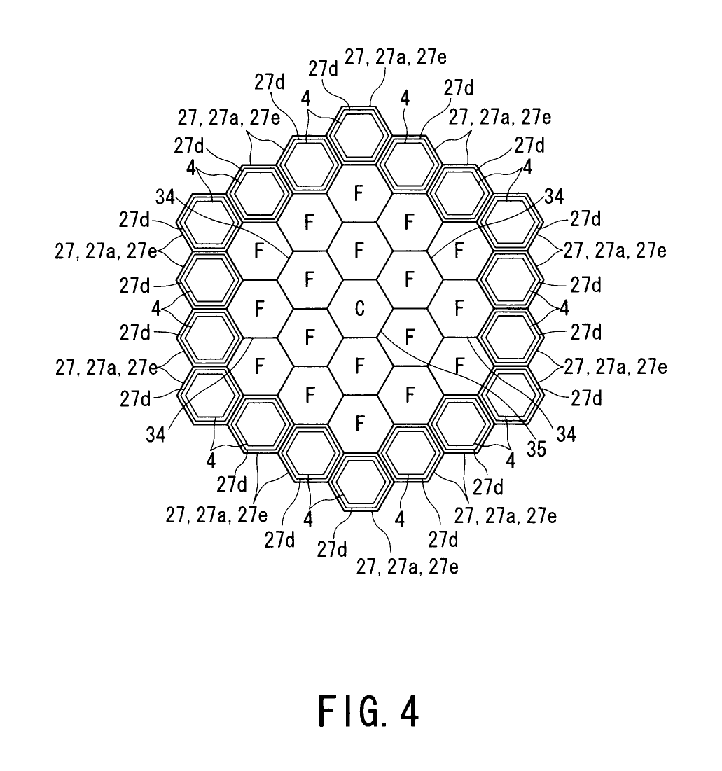

Still alternatively, as shown in FIG. 4, each of the void tubes 27 can have a two-layer tube structure including an inner tube 27d in which the corresponding reflector 4 is disposed and an outer tube 27e which, along with the inner tube 27d, forms a space into which the cover gas 31 is introduced. Since each of the void tubes 27 has the two-layer structure and the space into which the cover gas 31 is introduced is formed between the inner tube 27d and the outer tube 27e, the cover gas 31 can remain introduced in the inner tube 27d even if the outer tube 27e is broken and the primary coolant 30 enters the space, whereby the worth of the reflector 4 will not decrease. Alternatively, each of the void tubes 27 can have a multilayer tube structure including a plurality of inner tubes 27d. By forming each of the void tubes 27 so as to have such a multi-layer tube structure, the worth of the reflector 4 can be further prevented from decreasing even if a portion of the multi-layer tube structure is broken.

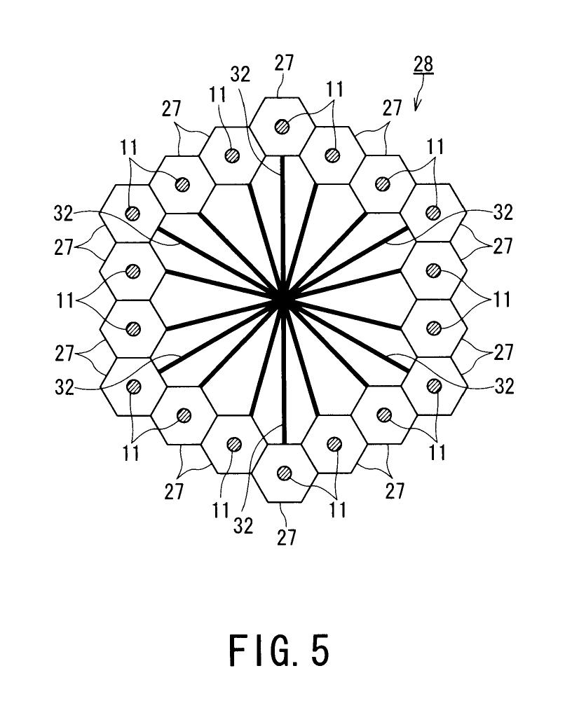

FIGS. 5, 6, and 7A to 7C are plan cross-sectional views schematically showing how the void tubes, which surround the reactor core of the reflector-controlled fast reactor according to the first embodiment of the present invention, are constrained.

As shown in FIG. 5, the void tube group 28 formed of the void tubes 27 mounted on and supported by the core support plate 13 is arranged into a hexagonal frame around the periphery (i.e., circumference) of the reactor core 2, and each pair of the void tubes 27 located on opposite sides of a substantially central point of the hexagonal frame are connected and constrained by the corresponding coupling shaft 32.

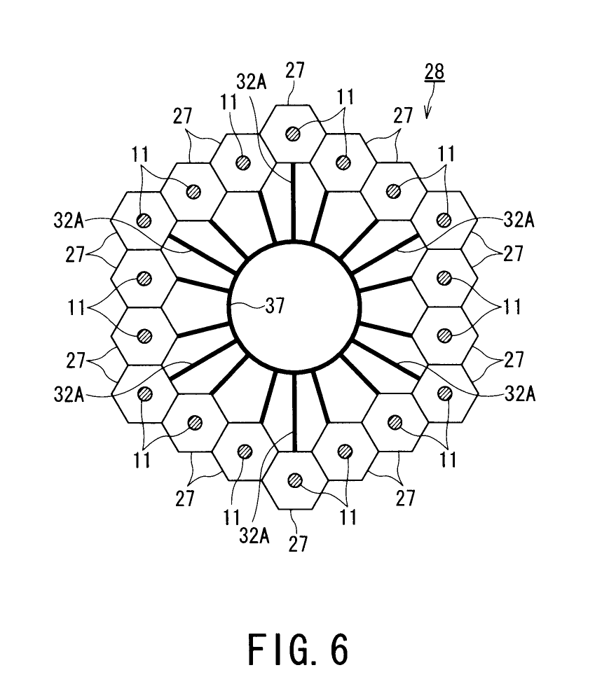

As shown in FIG. 6, the void tube group 28 formed of the void tubes 27 arranged into a hexagonal frame around the circumference of the reactor core 2 can alternatively be connected and constrained by coupling shafts 32A radially disposed toward the respective void tubes 27 from an annular connection ring 37 that is concentric with a substantially central point of the hexagonal shape and enclosed therein.

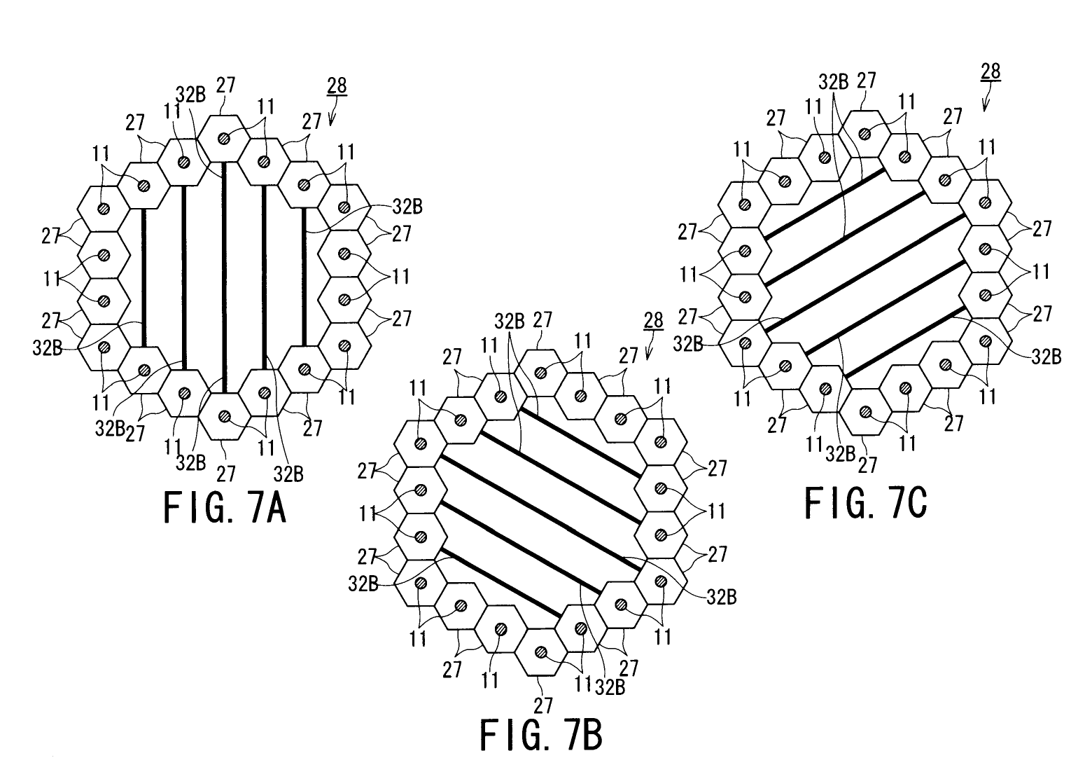

Still alternatively, as shown in FIG. 7A, the void tube group 28 formed of the void tubes 27 arranged into a hexagonal frame around the circumference of the reactor core 2 can be arrange into a hexagonal frame around the circumference of the reactor core 2, and each pair of void tubes 27 facing each other at both ends of a line parallel to each of the sides of the hexagonal shape can be connected and constrained by a coupling shaft 32B.

As shown in FIGS. 7A to 7C, since each of the lines parallel to each of the sides of the hexagonal shape intersects the line parallel to the adjacent one of the sides of the hexagonal shape, a set of coupling shafts 32B parallel to a certain one of the sides is desirably provided at a level different from the levels for the other sets in the height direction.

In the fast reactor 1 of the present embodiment, the primary coolant 30 may be eliminated in the region where the reflectors 4 are moved by disposing the void tubes 27 around the circumference of the reactor core 2. Further, the void tubes 27 can be filled with the cover gas 31, which allows a larger number of neutrons to leak those less in amount than the primary coolant 30, that is, which is inferior to the primary coolant 30 in terms of neutron reflection capability. That is, in a conventional fast reactor, the region where the reflectors 4 are moved is filled with the primary coolant 30, whereas in the fast reactor 1 of the present embodiment, the region where the reflectors 4 are moved is filled with the cover gas 31, thus being inferior to the primary coolant 30 in terms of neutron reflection capability and hence the degree of neutron leakage increases in this region. As a result, the fast reactor 1 of the present embodiment is superior to a conventional fast reactor in terms of the worth of the reflectors 4.

Further, by disposing the void tube group 28 so as to form a hexagonal multilayer frame, the total number of void tubes that surround the reactor core 2 can be increased, and the relative worth of the reflectors 4 can be further improved.

Further, since the void tubes 27, into which the cover gas 31 is introduced, can be disposed closer to the reactor core 2 than the vacuum- or gas-containing boxes disposed above the reflectors 4 in a conventional fast reactor, the primary coolant 30 having been present between the reactor core 2 and the reflectors 4 can be omitted, whereby high void effects can be advantageously provided.

Further, since the small-diameter tube portions 27b of the void tubes 27 are formed above the upper end of the reactor core 2 but below the liquid surface of the primary coolant 30, the primary coolant 30 heated in the reactor core 2 can readily be guided to the decay heat removal coil 16, the intermediate heat exchanger 15, and the electromagnetic pump 14. Moreover, since the cover gas 31 is introduced into the void tubes 27 through the gas introduction holes 27c, the heat in the void tubes 27 generated by the reflectors 4, the void tubes 27 and other components can be removed, and the interior of the void tubes 27 can be cooled. Further, since the void tubes 27 are connected and constrained by the coupling shafts 32, 32A or 32B, the strength to resist torsion and other harmful effects due to thermal stress and fluidic force induced by the reactor core 2 and the primary coolant 30 can be improved, as compared with a case where each of the void tubes 27 is independently disposed.

According to the fast reactor 1 of the present embodiment, a reflector-controlled fast reactor having an excellent worth of the reflectors can be provided by arranging the void tubes 27, each of which has a hexagonal plan cross-sectional shape that conforms to that of each of the fuel assemblies 34, around the circumference of the reactor core 2 and driving the reflectors 4 in the space in the void tubes 27 filled with the cover gas 31.

That is, it is possible to provide a fast reactor in which the primary coolant 30 present between the reactor core 2 and reflectors 4 can be eliminated to thereby decrease in neutron reflection toward the reactor core 2 in the region where the reflectors 4 are moved, to decrease in reactivity of the nuclear fuel and to increase in resistance to the temperature environment around the reactor core.

### Second Embodiment

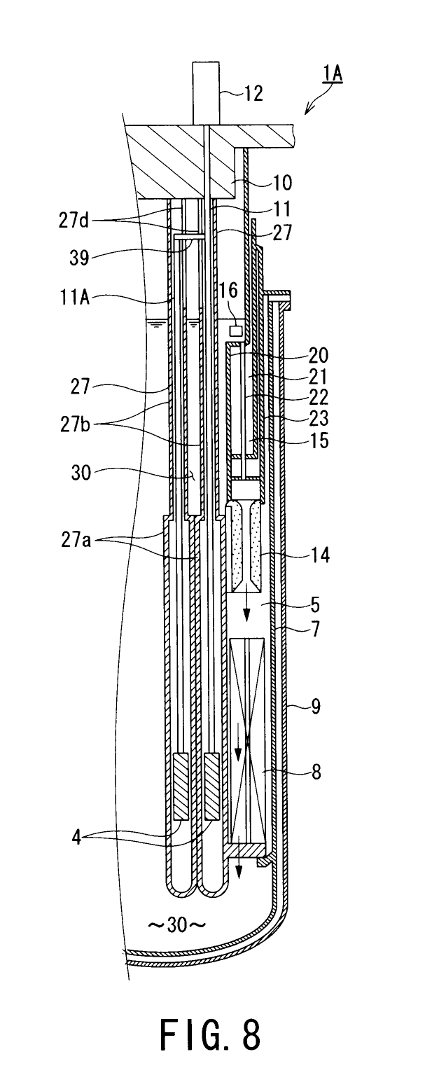

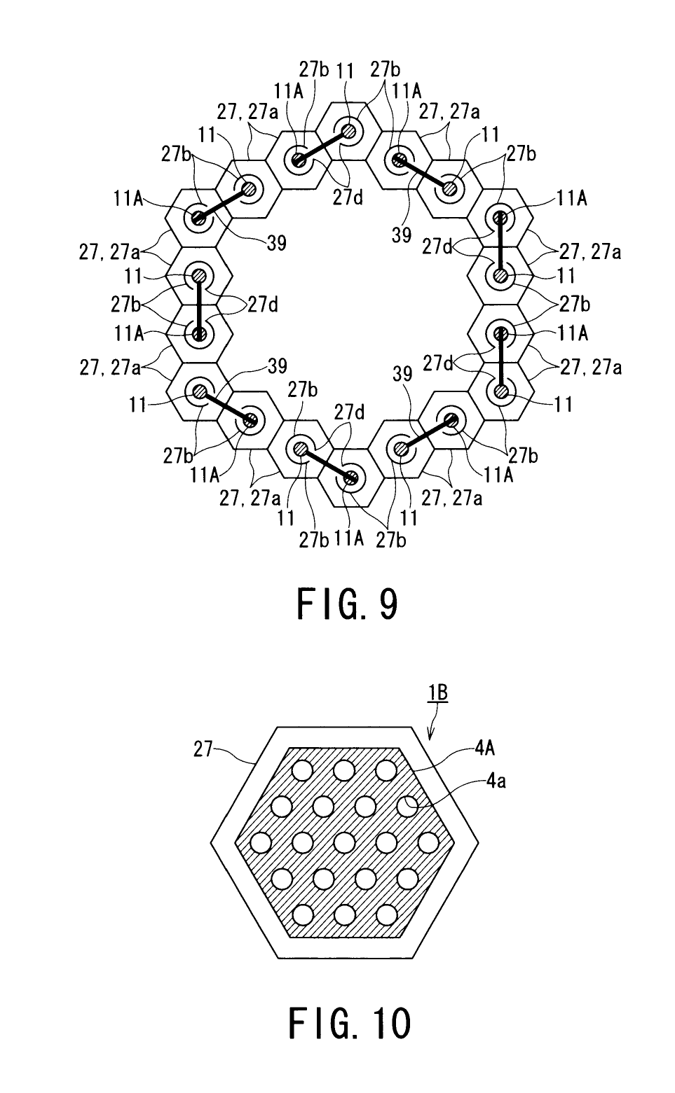

A second embodiment of the reflector-controlled fast reactor according to the present invention will be described with reference to FIGS. 8 and 9.

FIG. 8 is an axial cross-sectional view showing the configuration of the reflector-controlled fast reactor according to the second embodiment of the present invention.

FIG. 9 is a plan cross-sectional view showing a schematic configuration of the small-diameter tube portions of the void tubes constituting the reflector-controlled fast reactor according to the second embodiment of the present invention.

The same reference numerals are added to components or members of the fast reactor 1A of the second embodiment corresponding to those used in the fast reactor 1 of the first embodiment, and duplicated description thereof will be omitted herein.

As shown in FIGS. 8 and 9, in the fast reactor 1A, the reflector 4 suspended in the large-diameter tube portion 27a of one of adjacent two void tubes 27 by the drive shaft 11 passing through the upper plug 10 is supported in such a way that the reflector 4 can be moved in the vertical direction by the corresponding reflector drive apparatus 12. The drive shaft 11 inserted into the small-diameter tube portion 27b of this void tube 27 is connected to a drive shaft coupling shaft 39 protruding toward a substantially central portion of the adjacent other void tube 27.

The reflector 4 disposed in the large-diameter tube portion 27a of the other void tube 27 of the adjacent two void tubes 27 is suspended by a drive shaft 11A inserted into the small-diameter tube portion 27b of the other void tube 27. The upper end of the drive shaft 11A is connected to the drive shaft coupling shaft 39 protruding from the one void tube 27.

That is, the reflector 4 suspended by the drive shaft 11 in the large-diameter tube portion 27a of the one void tube 27 of the adjacent two void tubes 27 and the reflector 4 suspended by the drive shaft 11A in the large-diameter tube portion 27a of the other void tube 27 are connected to each other via the drive shaft coupling shaft 39 protruding from the drive shaft 11.

The drive shaft coupling shaft 39 is provided within the range over which the two reflectors 4 are moved in the vertical direction by the reflector drive apparatus 12 and at a level above the liquid surface of the primary coolant 30 in the space always filled with the cover gas 31. A cutout 27d is provided in the small-diameter tube portion 27b of each of the void tubes 27 over the range within which the drive shaft coupling shaft 39 moves as the two reflectors 4 move in the vertical direction.

The reflectors 4 disposed in three or more adjacent void tubes 27 can alternatively be connected to each other via a plurality of drive shaft coupling shafts 39.

According to the fast reactor 1A of the present embodiment, since the reflectors 4 disposed in adjacent void tubes 27 are connected via the corresponding drive shaft coupling shaft 39, the number of reflector drive apparatus 12 for driving the reflectors 4 and the number of holes in the upper plug 10 through which the drive shafts 11 are inserted may be made smaller than the number of reflectors 4 and the number of void tubes 27, which may hence contribute to a simplified, readily controlled system (not shown) that drives and controls the reflector drive apparatus 12.

### Third Embodiment

A third embodiment of the reflector-controlled fast reactor according to the present invention will be described with reference to FIG. 10.

FIG. 10 is a plan cross-sectional view showing a schematic configuration of a reflector disposed in each of the void tubes constituting the reflector-controlled fast reactor according to the third embodiment of the present invention.

The same reference numerals are added to components or members of the fast reactor 1B of the third embodiment corresponding to those used in the fast reactor 1 of the first embodiment, and duplicated description thereof will be omitted herein.

As shown in FIG. 10, the large-diameter tube portion 27a of each of the void tubes 27 constituting the fast reactor 1B has a hexagonal plan cross-sectional shape. A reflector 4A having a hexagonal plan cross-sectional shape and a hole 4a extending in the longitudinal direction is disposed in the large-diameter tube portion 27a but spaced apart from the inner wall thereof.

A plurality of holes 4a may be provided, and in the present embodiment, for example, 29 holes 4a are provided in the reflector 4A.

The heat generated in the reflector 4A during the operation of the fast reactor 1B heats the cover gas 31 with which the void tube 27 is filled. The reflector 4A is cooled when the heated cover gas 31 is discharged out of the void tube 27. Each of the holes 4a in the reflector 4A forms a flow path through which the heated cover gas 31 to be discharged out of the void tube 27 flows. Further, since providing the holes 4a increases the surface area of the reflector 4A, the cover gas 31 cools the reflector 4A more efficiently.

### Fourth Embodiment

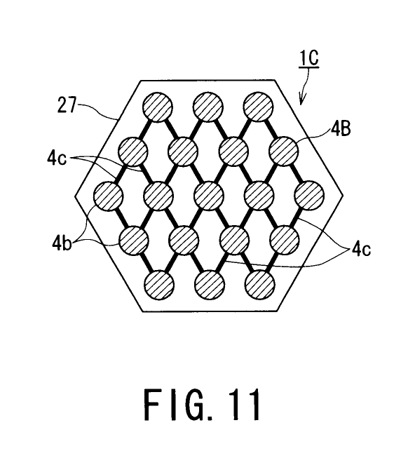

A fourth embodiment of the reflector-controlled fast reactor according to the present invention will be described with reference to FIG. 11.

FIG. 11 is a plan cross-sectional view showing a schematic configuration of a reflector disposed in each of the void tubes constituting the reflector-controlled fast reactor according to the fourth embodiment of the present invention.

The same reference numerals are added to components or members of the fast reactor 1C of the second embodiment corresponding to those used in the fast reactor 1 of the first embodiment, and duplicated description thereof will be omitted herein.

As shown in FIG. 11, the large-diameter tube portion 27a of each of the void tubes 27 constituting the fast reactor 1C has a hexagonal plan cross-sectional shape. A reflector 4B formed of a plurality of cylinders 4b secured by securing shafts 4c is disposed in the large-diameter tube portion 27a but spaced apart from the inner wall thereof.

The plurality of cylinders 4b that form the reflector 4B are arranged into a hexagonal shape as a whole, and the outer peripheral edge portions of the plurality of cylinders 4b are positioned along the inner wall of the large-diameter tube portion 27a of the void tube having a hexagonal plan cross-sectional shape. The cylinders 4b are spaced apart from each other so that the cover gas 31 flows through the space therearound. A space between the adjacent cylinders 4b is constrained by the corresponding securing shaft 4c.

The heat generated in the reflector 4B during the operation of the fast reactor 1C heats the cover gas 31 with which the void tube 27 is filled. The reflector 4B is cooled when the heated cover gas 31 is discharged out of the void tube 27. Since the reflector 4B is constructed by bundling the plurality of cylinders 4b, the surface area of the reflector 4B increases, as compared with the case where the reflector is a hexagonal column, and hence, the reflector 4B can cool the cover gas 31 more efficiently.

### Fifth Embodiment

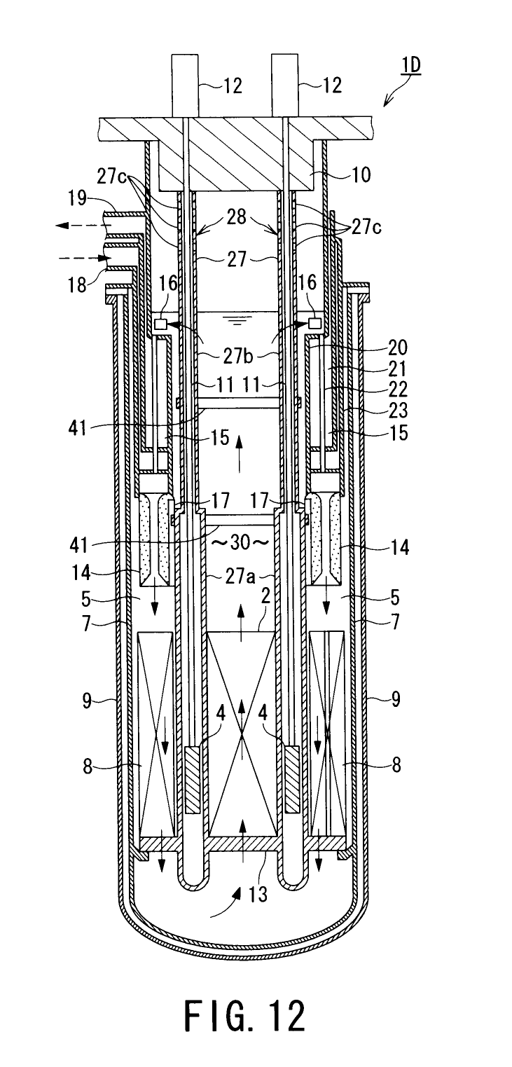

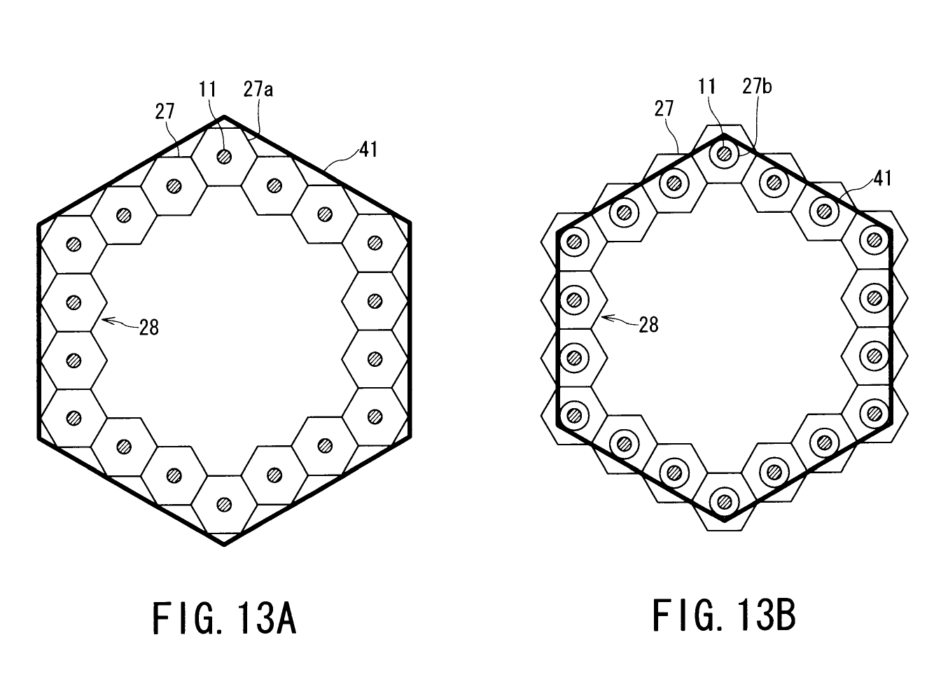

A fifth embodiment of the reflector-controlled fast reactor according to the present invention will be described with reference to FIGS. 12 and 13.

FIG. 12 is an axial cross-sectional view showing the configuration of the reflector-controlled fast reactor according to the fifth embodiment of the present invention.

The same reference numerals are added to components or members of the fast reactor 1D of the fourth embodiment corresponding to those used in the fast reactor 1 of the first embodiment, and duplicated description thereof will be omitted herein.

As shown in FIG. 12, in this embodiment, the void tubes 27, which form the fast reactor 1D, are bundled by a connection band 41 at a level higher than the upper end of the reactor core 2, and accordingly, the displacement of the void tubes 27 is constrained in the direction intersecting the longitudinal direction thereof. For example, both, the large-diameter tube portions 27a and the small-diameter tube portions 27b are provided with the connection band 41. When the connection bands 41, which constrain the void tubes 27, are arranged in such a way that the void tube group 28 shows sufficient rigidity, the upper ends of the small-diameter tube portions 27b are not required to abut against the upper plug 10. In this case, only by opening the upper end of each of the small-diameter tube portions 27b, the gas introduction holes 27c may be omitted.

FIG. 13 shows plan cross sections schematically showing how the void tubes, which surround the reactor core of the reflector-controlled fast reactor according to the fifth embodiment of the present invention, are constrained. FIG. 13A schematically shows how the large-diameter tube portions of the void tubes are constrained, and FIG. 13B schematically shows how the small-diameter tube portions of the void tubes are constrained.

As shown in FIGS. 13A and 13B, the void tube group 28 composed of the void tubes 27 mounted on and supported by the core support plate 13 is arranged into a hexagonal frame around the circumference of the reactor core 2, and the peripheral portion of the hexagonal shape is constrained by the connection bands 41.

According to the fast reactor 1D of the present embodiment, since the void tube group 28 formed of the void tubes 27 is constrained by the connection bands 41 provided therearound, the path through which the primary coolant 30 flows can be sufficiently ensured in the space above the reactor core 2.

### Sixth Embodiment

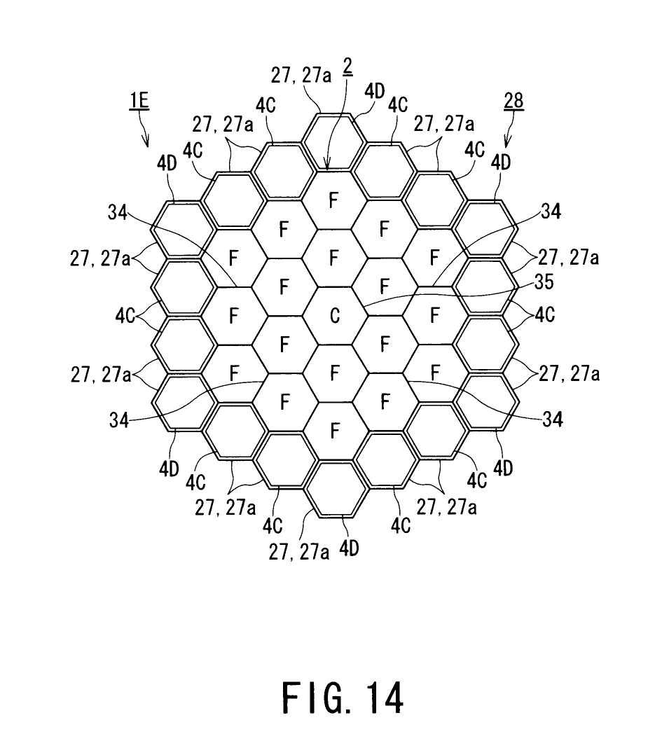

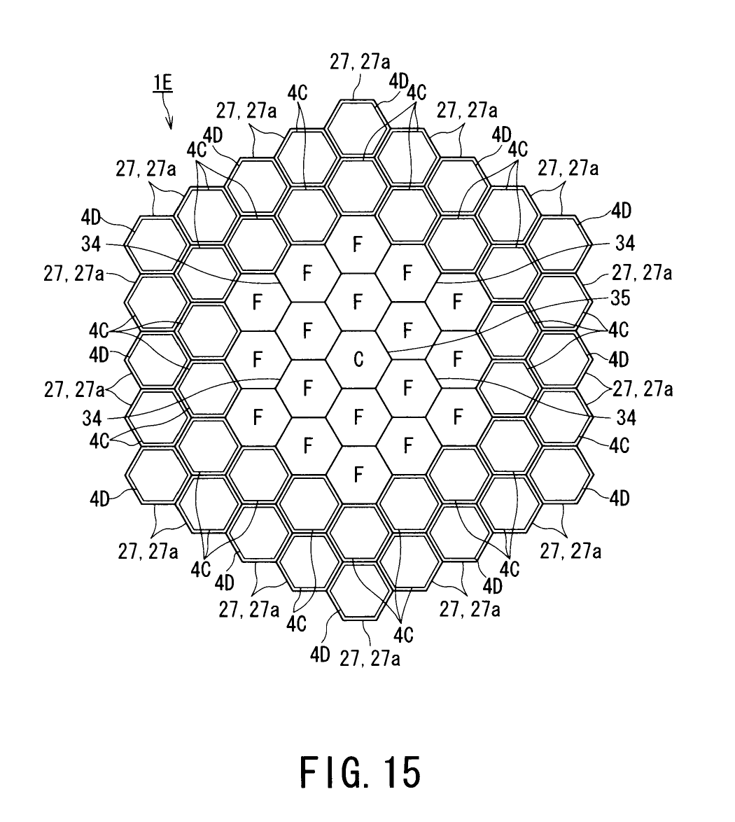

A sixth embodiment of the reflector-controlled fast reactor according to the present invention will be described with reference to FIGS. 14 and 15.

FIGS. 14 and 15 are plan cross-sectional views showing schematic configurations of the reactor core section of the reflector-controlled fast reactor according to the sixth embodiment of the present invention.

The same reference numerals are added to components or members of the fast reactor 1E of the fifth embodiment corresponding to those used in the fast reactor 1 of the first embodiment, and duplicated description thereof will be omitted herein.

As shown in FIG. 14, in the fast reactor 1E, the reactor core 2 composed of the fuel assemblies 34 (indicated by the character F in FIG. 14) and the reactor shutdown rod 35 (indicated by the character C in FIG. 14) is surrounded by the void tubes 27, each of which includes the large-diameter tube portion 27a having a hexagonal cross-sectional shape, like each of the fuel assemblies 34. For example, eighteen (18) void tubes 27 are disposed around the reactor core 2. That is, the void tube group 28 composed of the void tubes 27 is arranged into a hexagonal frame around the circumference of the reactor core 2.

First reflectors 4C and second reflectors 4D, each of which has a hexagonal cross-sectional shape, are disposed in the large-diameter tube portions 27a of the void tubes 27, each of which also has a hexagonal cross-sectional shape, and are spaced apart from the inner wall of the respective large-diameter tube portions 27a.

The speed at which the first reflectors 4C move in the vertical direction in the corresponding void tubes 27 is set to be greater than the speed at which the second reflectors 4D move in the vertical direction in the corresponding void tubes 27. It may be also possible to fix the second reflectors 4D so as not to move in the vertical direction in the corresponding void tubes 27. It is desirable that the first reflectors 4C and the second reflectors 4D are uniformly disposed around the reactor core 2. For example, the second reflectors 4D may be disposed in the void tubes 27 positioned at the apexes of the hexagonal shape formed by the void tube group 28, and the first reflectors 4C may be disposed in the void tubes 27 positioned in the other locations.

Alternatively, the void tubes 27, which surround the reactor core 2, may be arranged into a hexagonal frame formed of a plurality of layers around the periphery of the reactor core 2 with the core 2 being the center thereof, as shown in FIG. 15. For example, 24 void tubes 27 that form two layers are disposed around the reactor core 2. The first reflectors 4C and the second reflectors 4D are disposed in these void tubes 27.

According to the fast reactor 1E of the present embodiment, there can be provided a fast reactor capable of controlling the reactivity therein more precisely by combining reflectors that move at different speeds in comparison with the reactivity control manner performed in a conventional fast reactor.

### Seventh Embodiment

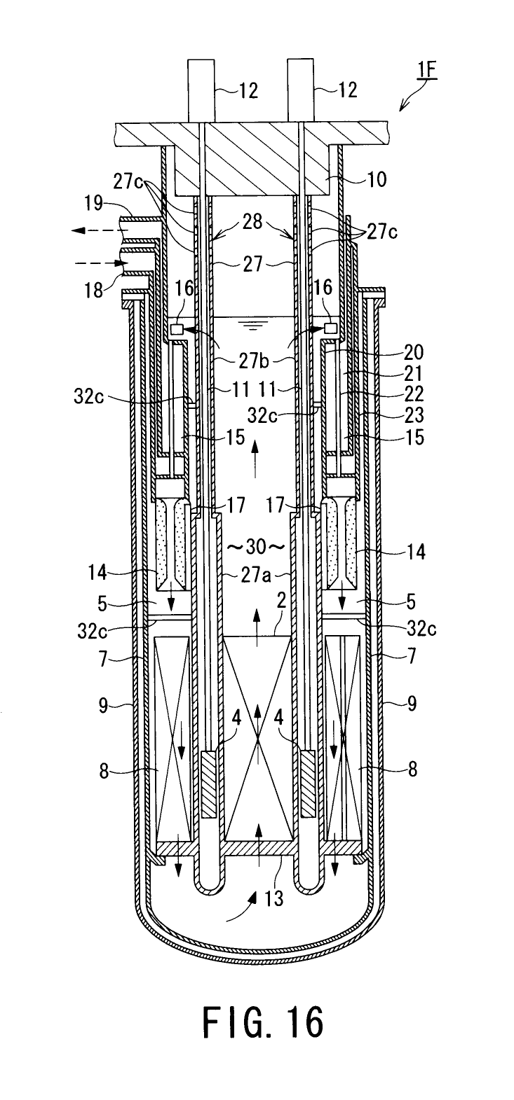

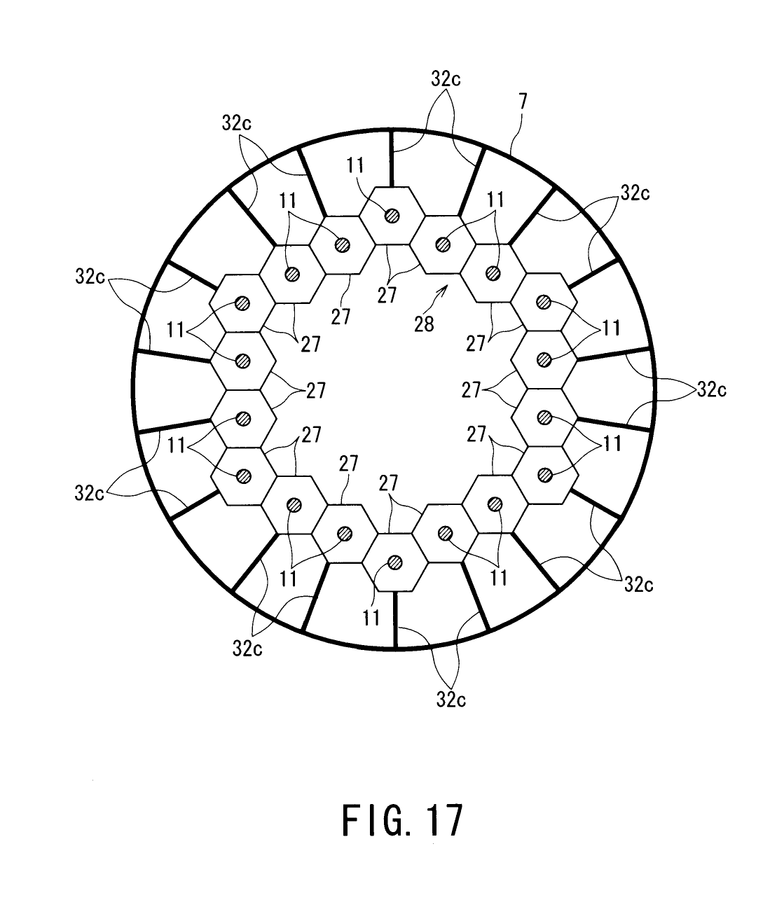

A seventh embodiment of the reflector-controlled fast reactor according to the present invention will be described with reference to FIGS. 16 and 17.

FIG. 16 is an axial cross-sectional view showing the configuration of the reflector-controlled fast reactor according to the seventh embodiment of the present invention.

The same reference numerals are added to components or members of the fast reactor 1F of the seventh embodiment corresponding to those used in the fast reactor 1 of the first embodiment, and duplicated description thereof will be omitted herein.

As shown in FIG. 16, the void tubes 27 in the fast reactor 1F are connected to the reactor vessel 7 via coupling shafts 32C, so that the displacement of the void tube 27 is constrained in the direction intersecting the longitudinal direction thereof. The coupling shafts 32C are provided at a level higher than the upper end of the reactor core 2. For example, both the large-diameter tube portions 27a and the small-diameter tube portions 27b are provided with the coupling shafts 32C. When the coupling shafts 32C, which constrain the void tubes 27, are arranged in such a way that the void tube group 28 shows sufficient rigidity, it is not necessary for the upper ends of the small-diameter tube portions 27b to abut against the upper plug 10. In this case, the upper end of each of the small-diameter tube portions 27b can be opened, and the gas introduction holes 27c can be eliminated.

FIG. 17 is a plan cross-sectional view schematically showing the constraining condition of the void tubes, which surround the reactor core of the reflector-controlled fast reactor 1F according to the seventh embodiment of the present invention.

As shown in FIG. 17, the void tube group 28 composed of the void tubes 27 mounted on and supported by the core support plate 13 is arranged into a hexagonal frame around the periphery of the reactor core 2. The void tubes 27, which constitute the void tube group 28, and the reactor vessel 7 are connected via the coupling shafts 32C radially disposed between the peripheral portion of the hexagonal shape frame formed by the void tube group 28 and the inner wall of the reactor vessel 7.

According to the fast reactor 1F of this seventh embodiment, since the void tubes 27 are connected to and constrained by the inner wall of the reactor vessel 7 via the coupling shafts 32C, the strength can be improved with respect to torsion and other harmful effects due to thermal stress and fluidic force induced by the reactor core 2 and the primary coolant 30 can be improved, as compared with a case where each of the void tubes 27 is independently disposed.

### Eighth Embodiment

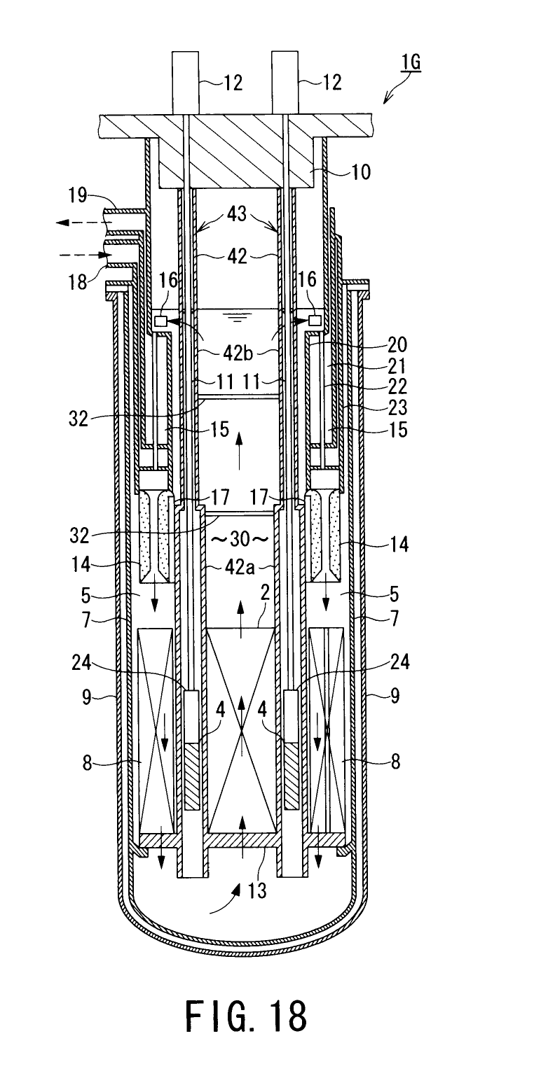

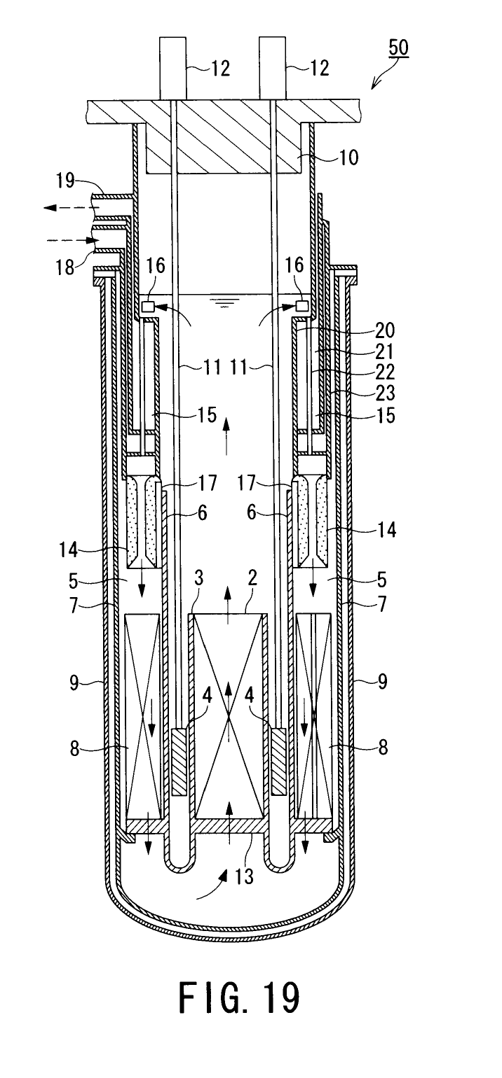

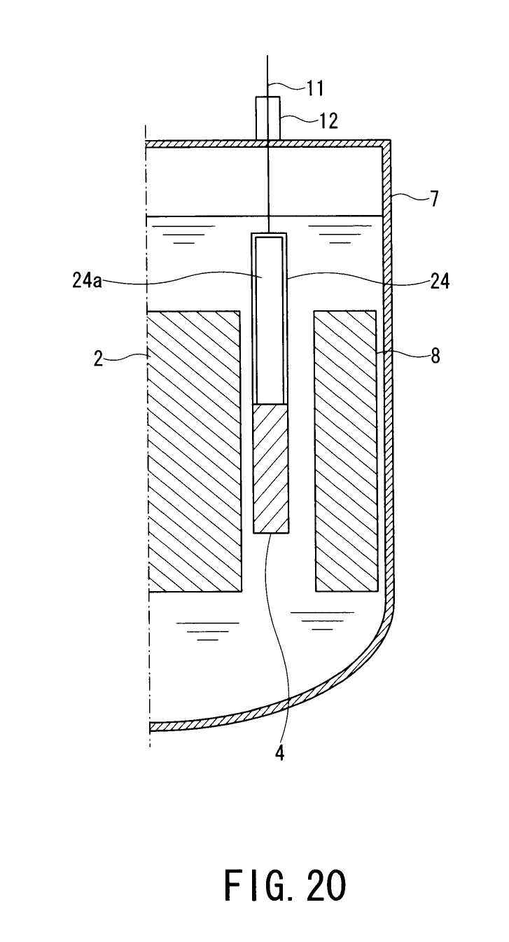

An eighth embodiment of the reflector-controlled fast reactor according to the present invention will be described with reference to FIG. 18.

FIG. 18 is an axial cross-sectional view showing the configuration of the reflector-controlled fast reactor according to the eighth embodiment of the present invention.

The same reference numerals are added to components or members of the fast reactor 1G of the eighth embodiment corresponding to those used in the fast reactor 1 of the first embodiment, and duplicated description thereof will be omitted herein.

As shown in FIG. 18, the reflector-controlled fast reactor 1G includes a reactor core 2 composed of nuclear fuel assemblies, and the reactor core 2 has a cylindrical shape as a whole. The outer circumference of the reactor core 2 is surrounded by a reflector guide tube group 43 composed of a plurality of reflector guide tubes 42. Reflectors 4, which as a whole surround the reactor core 2, are disposed in the respective reflector guide tubes 42. The outer circumference of the reflector guide tube group 43 forms the inner wall of a coolant flow path 5, through which a primary coolant 30 flows. A reactor vessel 7, which forms the outer wall of the coolant flow path 5, is disposed outside the reflector guide tube group 43 with a space apart therefrom. A neutron shield 8 is disposed in the coolant flow path 5 and surrounds the reactor core 2. A guard vessel 9, which protects the reactor vessel 7, is provided outside the reactor vessel 7.

A box 24 having a space 24a formed therein is integrally connected to an upper portion of each of the reflectors 4. The space 24a contains a vacuum or a gas, which is inferior to the primary coolant 30 in terms of neutron reflection capability. The upper end of the box 24 is suspended by a drive shaft 11 passing through an upper plug 10 and supported in such a way that the box 24 and the reflector 4 are movable in the vertical direction by a reflector drive apparatus 12. That is, the drive shaft 11 (hence, the reflector 4) and the box 24 are moved in the vertical direction in the corresponding reflector guide tube 42 when the reflector drive apparatus 12 is driven. By moving the reflector 4 and the box 24, the leakage of neutrons from the reactor core 2 can be adjusted, and hence, the reactivity in the reactor core 2 can be controlled.

Each of the reflector guide tubes 42, which forms a region where the corresponding reflector 4 moves in the vertical direction, is formed of a large-diameter tube portion 42a, through which the reflector 4 and the box 24 move in the vertical direction, and a small-diameter tube portion 42b, which is provided above the large-diameter tube portion 42a and into which the drive shaft 11 suspending the reflector 4 and the box 24 is inserted. The large-diameter tube portion 42a has a length over which the reflector 4 and the box 24 can move from the lower end to the upper end of the reactor core 2. On the other hand, the small-diameter tube portion 42b communicates with an upper end portion of the large-diameter tube portion 42a at a level lower than the liquid surface of the primary coolant 30.

The reactor core 2 and the neutron shield 8 are mounted on and supported by a core support plate 13. The reflector guide tubes 42 extend upward from the core support plate 13, on which the reactor core 2 is mounted, and the annular space between the outer circumference of the reflector guide tube group 43 composed of the reflector guide tubes 42 and the reactor vessel 7 forms the coolant flow path 5. An annular electromagnetic pump 14 is disposed in the coolant flow path 5 above the neutron shield 8 disposed therein. An intermediate heat exchanger 15 is disposed above the electromagnetic pump 14. A decay heat removal coil 16 is disposed above the intermediate heat exchanger 15.

The intermediate heat exchanger 15 and the electromagnetic pump 14 are integrated with each other and further continuously connected to and suspended by an outer shroud 23, which is an upper structure of the fast reactor 1G. The intermediate heat exchanger 15 has a tube and a shell through which the primary coolant 30 and a secondary coolant flow respectively. A seal bellows 17, which absorbs expansion and contraction due to the heat generated in the fast reactor 1G and defines the coolant flow path 5, is provided between a lower end portions of the intermediate heat exchanger 15 and electromagnetic pump 14 and upper end portions of the large-diameter tube portions 42a of the reflector guide tubes 42. The intermediate heat exchanger 15 has an inner barrel 20 and an outer barrel 21, and a heat transfer tube 22 is disposed between the inner barrel 20 and the outer barrel 21.

A lower portion of the large-diameter tube portion 42a of each of the reflector guide tubes 42 is formed of a portion that abuts against the upper surface of the core support plate 13 and a portion that protrudes downward from the core support plate 13 for positioning the reflector 4 below the lower end of the reactor core 2. The upper end of the small-diameter tube portion 42b of each of the reflector guide tubes 42 abuts against the upper plug 10 and is supported thereby. The primary coolant 30 is introduced into the reflector guide tubes 42.

The solid arrows shown in FIG. 18 indicate the direction in which the primary coolant 30 flows. As indicated by the solid arrows, the primary coolant 30 is moved by the electromagnetic pump 14 downward through the coolant flow path 5, passes through the neutron shield 8, and reaches the bottom of the reactor vessel 7. The primary coolant 30 is then redirected and flows upward through the reactor core 2, and the temperature of the primary coolant 30 is increased by the heat generated in the nuclear fission of the nuclear fuel in the reactor core 2. The heated primary coolant 30 flows into the tube of the intermediate heat exchanger 15 located in an upper portion of the reactor vessel 7. Further, the primary coolant 30 flows out of the intermediate heat exchanger 15 after performing the heat exchange with the secondary coolant therein, and is moved downward again by the operation of the electromagnetic pump 14. Unlike the primary coolant 30, the secondary coolant externally enters the fast reactor 1G through an inlet nozzle 18 and flows into the shell of the intermediate heat exchanger 15. Thereafter, the secondary coolant is heated by the primary coolant 30 in the intermediate heat exchanger 15 and then flows out of the fast reactor 1G through an outlet nozzle 19. The heat of the secondary coolant is converted into, for example, power for driving an electric generator.

In the fast reactor 1G, the reflectors 4 and the boxes 24 are disposed in the respective reflector guide tubes 42 arranged around the outer circumference of the reactor core 2. As a result, in the fast reactor 1G, the reflectors 4 and the boxes 24 can be disposed closer to the reactor core 2 than in the configuration of a conventional fast reactor in which the reflectors 4 and the boxes 24 are disposed outside a cylindrical core barrel that surrounds the reactor core 2. Further, the reflector guide tubes 42 can support the vertical motion of the reflectors 4 and the boxes 24 suspended by the respective drive shafts 11, each having a large ratio of the longitudinal length to the shaft diameter.

The fast reactor 1G of the present embodiment is a reflector-controlled type fast reactor which can provide an excellent worth of the reflectors by arranging the reflector guide tubes 42, each of which has a hexagonal cross-sectional shape that conforms to that of the fuel assembly 34, around the circumference of the reactor core 2 and by driving the reflectors 4 in the space in the reflector guide tubes 42. That is, it is possible to provide a fast reactor in which the amount of primary coolant 30 present between the reactor core 2 and reflectors 4 can be reduced as small as possible to thereby decrease the neutron reflection toward the reactor core 2 in the region where the reflectors 4 move, decrease reactivity of the nuclear fuel, and increase resistance to the temperature environment around the reactor core.

1. A reflector-controlled fast reactor in which a neutron reflector disposed outside the rector core is moved vertically to adjust leakage of neutrons from the reactor core to thereby control reactivity of the rector core,
wherein a region, which is located around the reactor core and in which the neutron reflector moves, is surrounded by a material inferior to the coolant in terms of neutron reflection capability.

2. The reflector-controlled fast reactor according to claim 1, wherein the region in which the neutron reflector moves is constituted by void tubes that surround the reactor core and are filled with the material inferior to the coolant in terms of the neutron reflection capability.

3. The reflector-controlled fast reactor according to claim 2, wherein each of the void tube has a plan cross-sectional shape that is substantially same as that of a hexagonal fuel assembly constituting the reactor core.

4. The reflector-controlled fast reactor according to claim 3, wherein the void tubes are arranged into a hexagonal frame formed of a plurality of layers around the reactor core.

5. The reflector-controlled fast reactor according to claim 4, wherein each pair of the void tubes located on opposite sides of a substantially central point of the hexagonal frame are connected and constrained by a coupling shaft.

6. The reflector-controlled fast reactor according to claim 2, further comprising drive shafts inserted into the void tubes, respectively, and suspend the neutron reflectors and a reflector drive apparatus that moves the neutron reflector via the drive shafts in the vertical direction, wherein the drive shafts inserted into adjacent ones of the void tubes are connected via a drive shaft coupling shaft so that the number of the reflector drive apparatus is smaller than the total number of the reflectors.

7. The reflector-controlled fast reactor according to claim 2, wherein each of the void tubes has a multilayer tube structure.

8. The reflector-controlled fast reactor according to claim 2, wherein peripheral portions of the void tubes which surround the reactor core are constrained by a connection band.

9. The reflector-controlled fast reactor according to claim 2, wherein the void tubes are connected via coupling shafts to an inner wall of a reactor vessel in which the reactor core is housed.

10. The reflector-controlled fast reactor according to claim 2, wherein each of the void tubes is formed with a gas introduction hole through which a cover gas filling a portion above the liquid surface of the coolant is introduced.

11. The reflector-controlled fast reactor according to claim 1, wherein the neutron reflector is formed with a path through which the material inferior to the coolant filling the void tube in terms of neutron reflection capability flows.

12. The reflector-controlled fast reactor according to claim 1, wherein a plurality of neutron reflectors are disposed and include a group of first neutron reflectors and a group of second neutron reflectors that move at a speed lower than the speed at which the first neutron reflectors move.

13. The reflector-controlled fast reactor according to claim 12, wherein the second neutron reflectors are fixed around the reactor core.

14. A reflector-controlled fast reactor in which a neutron reflector disposed outside the rector core is moved vertically to adjust leakage of neutrons from the reactor core to thereby control reactivity of the rector core,
wherein a box containing a material inferior to the coolant in terms of neutron reflection capability is disposed above the neutron reflector, and the neutron reflector and the box are disposed in a reflector guide tube.
